(19) United States
(12) Patent Application Publication
(10) Pub. No.: US 2011/0286876 A1
(43) Pub. Date: Nov. 24, 2011

(54) THERMAL MANAGEMENT COMPOSITE MATERIALS

(75) Inventors: Nan Jiang, Austin, TX (US); Samuel Kim, Austin, TX (US); Zvi Yaniv, Austin, TX (US)

(73) Assignee: APPLIED NANOTECH HOLDINGS, INC., Austin, TX (US)

(21) Appl. No.: 13/113,264

(22) Filed: May 23, 2011

Related U.S. Application Data
(60) Provisional application No. 61/347,627, filed on May 24, 2010.

(51) Int. Cl. B22F 3/12; B22F 7/00; B82Y 30/00

(52) U.S. Cl. 419/11; 977/742

(57) ABSTRACT

Graphite aluminum composites for use in thermal management applications, such as heat sinks, are manufactured using pressure molds. The materials may be mixed previous to insertion into the mold, or can be mixed within the mold. Further, graphitic particles, such as graphitic needle coke surfaces, can be coated with the aluminum before the mold process is performed. Further, ceramic sheets can be inserted into the mixture before the mold process is performed so that the molded material can then be sliced to provide a carbon aluminum composite plate with a ceramic sheet on one of its surfaces.

The present application claims priority to U.S. Provisional Patent Application Ser. No. 61/347,627, which is hereby incorporated by reference herein.

### BACKGROUND

There are several factors or functions when designing thermal sinks. One function is to spread the heat to the environment. Another function is important in case hot spots exist. In such a situation, the concern is how to very quickly transfer the heat from the hot spot and diffuse it to the heat sink. Most high-power, high-speed electronic devices and systems require the high thermal diffusivity materials to modulate temperature and eliminate the “hot spots.” The physical term that represents this property is referred to as thermal diffusivity, which is the ratio of thermal conductivity to volumetric heat capacity. Materials with high thermal diffusivity conduct heat quickly in comparison to their volumetric heat capacity (thermal bulk), meaning that the temperature wave moves quickly from the hot spot to the surroundings. In addition, from a practical standpoint, heat sink materials need to be light weight, easily and simply manufactured, and be inexpensive.

In summary, for material selection, the following criteria are considered:

(1) High Thermal Conductivity and High Thermal Diffusivity. A high thermal diffusivity will allow rapid diffusion of heat from the point of creation to a dissipative heat sink.

(2) Low Mass Density. Light weight is very important for electronic device heat sink applications. If the material is too heavy, it is hard to be used.

(3) Low cost.

(4) Feasibility for Mechanical Processing.

For practical applications, the heat sink material is machined and packaged into a specific size and shape. Ease of processing is desirable.

### BRIEF DESCRIPTION OF DRAWINGS

FIG. 1 illustrates a simplified schematic showing pressure casting of a mixture of graphitic needle cokes and aluminum particles;

FIG. 2 illustrates a simplified schematic of pressure casting of graphitic needle cokes coated with aluminum:

FIGS. 3A and 3B illustrate simplified schematics where ceramic sheets are inserted into carbon-aluminum powder materials within a pressure mold;

FIG. 4 illustrates a carbon-aluminum composite plate with a ceramic sheet;

FIG. 5 illustrates a process for manufacturing in accordance with an embodiment of the present invention;

FIG. 6 illustrates a process for manufacturing in accordance with an embodiment of the present invention;

FIG. 7 illustrates a process for manufacturing in accordance with an embodiment of the present invention; and

FIG. 8 shows digital images of graphitic needle cokes with approximate millimeter sizes (top image) and cokes with sub-millimeter sizes (bottom image).

### DETAILED DESCRIPTION

The elements on the periodic table that satisfy the above criteria are very limited. Table 1 lists several candidates with their feasibility remarked.

TABLE 1

| | Thermal | Thermal | | | | |
|---|---|---|---|---|---|---|
| | Conductivity | Diffusivity | Density | Processing | | Comprehensive |
| Materials | (W · m⁻¹ · K⁻¹) | (m² · s⁻¹) | (kg · m⁻³) | Feasibility | Cost | Remarks |
| Aluminum | 237 | 0.842 × 10⁻⁴ | 2.7 × 10³ | ◯ | ◯ | ⊚ |
| | ◯ | ◯ | ◯ | | | |
| Copper | 386 | 1.123 × 10⁻⁴ | 8.92 × 10³ | ◯ | ◯ | ◯ |
| | ◯ | ◯ | X | | | |
| Silver | 429 | 1.656 × 10⁻⁴ | 10.92 × 10³ | ◯ | X | X |
| | ◯ | ◯ | X | | | |
| Diamond | 2000 | 11.2 × 10⁻⁴ | 3.5 × 10³ | XX | XX | X |
| | ⊚ | ⊚ | ◯ | | | |
| Graphite | 1996 | 12.2 × 10⁻⁴ | 2.27 × 10³ | ◯ | ◯ | ⊚ |
| (in plane) | ⊚ | ⊚ | ◯ | | | |

(⊚ - very good, ◯ - good, X - bad, XX - very bad)

In addition to the above criteria, a material's CTE (coefficient of thermal expansion) also may be considered. Usually, pure metals have high CTE values, and as a result they may cause high thermal stresses. Comparably, the composite materials are more preferable. As seen in Table 1, graphite aluminum composites are considered to possess advantages over the other materials.

The following describes manufacturing of composite materials according to embodiments of the present invention. In general, it is known that carbon materials and aluminum have poor wettability and affinity to one another; it is difficult to densely integrate them together. In other words, the C/Al (carbon aluminum) composite materials formed in typical ways, such as a conventional casting approach, include a large number of voids and slits, which result in a loss of contact between the carbon and aluminum materials, and poor mechanical/thermal properties.

Generally, previous manufacturing methods utilized impregnation of molten aluminum under very high pressure in a porous carbonaceous matrix. Such a process required very high pressure (approximately 100 MPa), a first step to melt the aluminum and then a second step to transport it in a liquid form to the impregnation site; in many cases, because the impregnation was not complete, the pre-manufacturing of the carbonaceous matrix took a very long time and was energy consuming. Another important issue is that after the C/Al composite is manufactured, the surface of this composite is electrically conductive due to the nature of the materials involved. Furthermore, the surface may be brittle and have pits. In many applications, the surfaces of these composites may require a very flat and smooth area, and particularly in some instances may require electrically insulating properties.

In embodiments of the present invention, pressure casting methods are utilized to overcome the foregoing problems. Furthermore, in the embodiments described herein, graphitic needle cokes are utilized, though other graphitic particles may be substituted, including, but not limited to, carbon nanotubes.

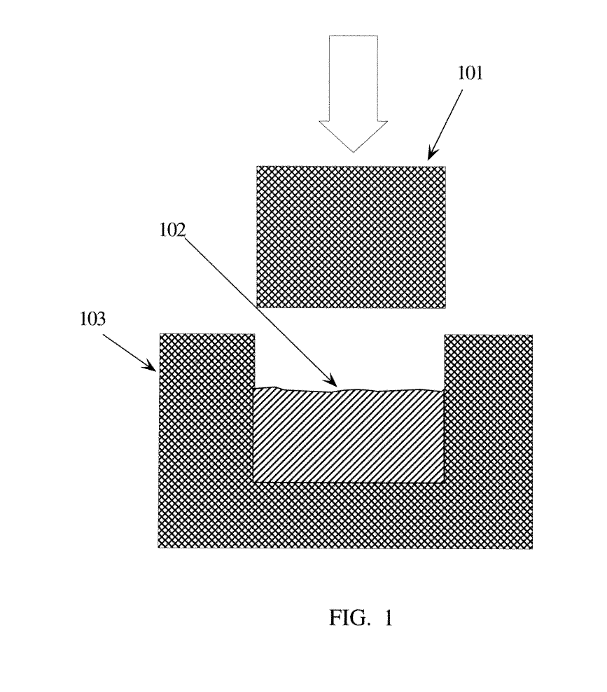

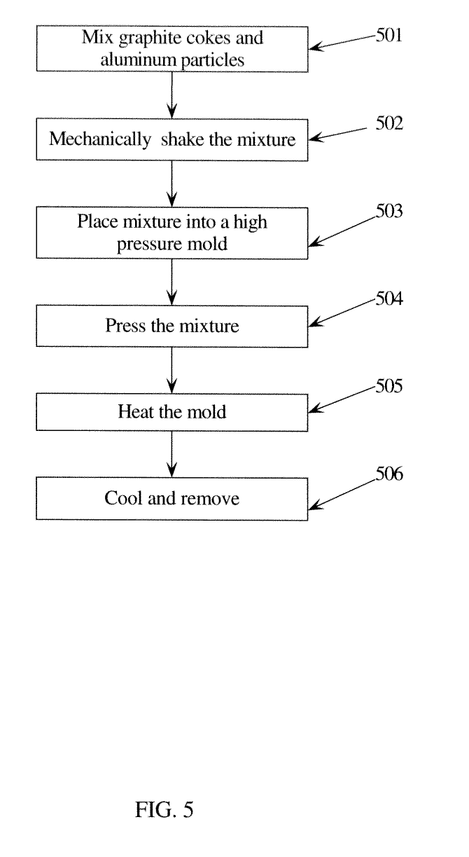

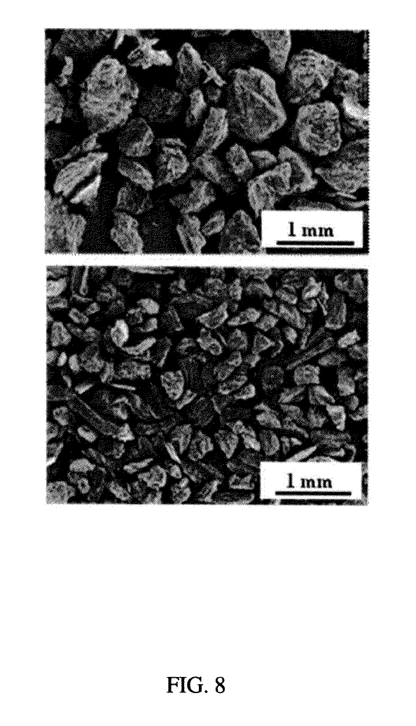

Referring to FIG. 1, there is illustrated a simple schematic drawing of an embodiment of the present invention whereby a mixture 102 of graphitic needle cokes and aluminum particles are pressure cast. Referring to FIGS. 1 and 5, in step 501, graphitic needle cokes and aluminum particles are mixed together in a specified ratio (e.g., Al:C: 5-20 wt %). Additives, such as silicon, may be included to provide a good thermal contact between the aluminum and carbon materials. The silicon additives may be silicon inclusive materials, such as silicon powders with a powder size smaller than 1 micron, and a preferred powder size of 10-100 nanometers. In step 502, next is performed a mechanical shaking of the C/Al mixture to obtain a uniform mixing of the materials by exploiting the anisotropic behavior of the graphitic needle cokes. The mechanically shaking of the mixture may be performed using an ultrasonic machine, stirring machine, or SpeedMix™ machine, or an equivalent thereof. As shown in FIG. 8, there are different sizes and shapes of graphitic needle cokes; their dimensions vary from millimeter to sub-millimeter sizes. A more uniform mixture can be obtained by selecting a mixture of different-sized graphitic needle cokes to form a dense topology compact. In step 503, the C/Al mixture 102 is placed or deposited into a pressure mold 103. The mold 103 may be either round or square in shape, and made of a steel alloy with a wall thickness over one centimeter to sustain the high pressure process. In step 504, a die 101 is used to press the C/Al mixture 102 by applying a mechanical pressure (indicated by the arrow in FIG. 1) on the mixture with the die 101 (e.g., 20-200 MPa). Due to the fact that impregnation of the pores in the carbonaceous matrix is not necessary, and the aluminum particles have been premixed with the graphitic needle cokes, the applied pressure may be lower, for example less than 50 MPa. In step 505, the mold 103 is heated to about 660° C. or greater for approximately 10 minutes or more to melt the aluminum. An alternative temperature range may be between 700°-750°. Heating of the molds in this disclosure may be performed by any well-known means. To sufficiently obtain a dense composite material, the pressing time may be longer than 10 minutes, such as 10-30 minutes. In step 506, the molded mixture is cooled, for example to room temperature, and removed from the mold 103.

In another embodiment of the present invention, the aforementioned manufacturing process of FIG. 5 is utilized, except that the anisotropic particles of aluminum and graphitic needle cokes are mixed during the shaking step 502. This may improve the uniformity and directionality of the mixture.

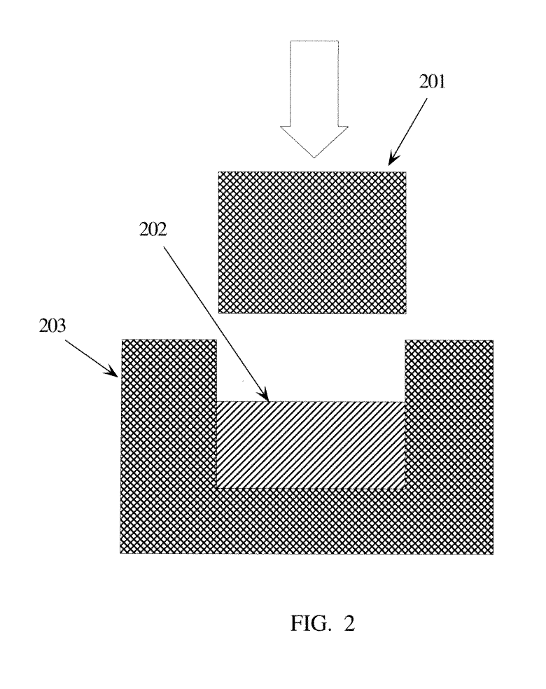

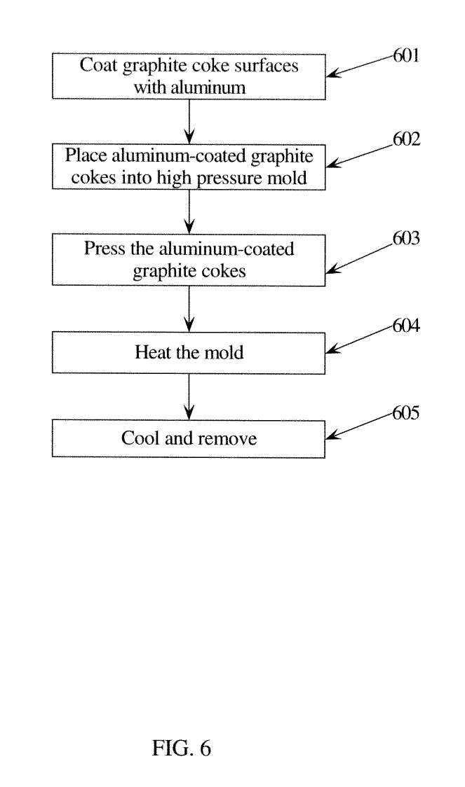

Referring to FIGS. 2 and 6, there is illustrated another embodiment of the present invention whereby graphitic needle cokes with aluminum coatings are pressure cast. In step 601, the surfaces of the graphitic needle cokes are coated with aluminum in a specified quantity (e.g., Al:C: 5-20 wt %). Additives, such as silicon, may be included to provide a good thermal contact between the aluminum and carbon materials. The silicon additives may be silicon inclusive materials, such as silicon powders with a powder size smaller than 1 micron, and a preferred powder size of 10-100 nanometers. Such coating processes may be, but are not limited to, inking, plating, and sputtering methods. For example, the aluminum coatings may be applied by any of the following processes: (1) dipping the graphitic needle cokes into aluminum inks followed by a 100° C. curing process, (2) plating the graphitic needle cokes in a magnetron sputtering chamber, and then using Ar ions to sputter an aluminum target to deposit aluminum on the graphitic needle cokes. In step 602, the aluminum-coated graphitic needle cokes 202 are placed into a pressure mold 203. In step 603, the aluminum-coated graphitic needle cokes 202 are pressed with a die 201 by applying a mechanical pressure (indicated by the arrow in FIG. 2) on the die 201 (e.g., 20-200 MPa). This pressure may be significantly lower, such as in the embodiment described above with respect to FIGS. 1 and 5. In step 604, the mold 203 is heated to about 660° C. or greater for approximately 10 minutes or more to melt the aluminum. An alternative temperature range may be between 700°-750°. To sufficiently obtain a dense composite material, the pressing time may be longer than 10 minutes, such as 10-30 minutes. In step 605, the molded material is cooled to room temperature and removed from the mold 203.

In order to obtain an electrically insulative surface for the C/Al composite as described above, there are a number of approaches, but one needs to consider the insulative properties and also the influence of this layer on the thermal properties of the final material. In some cases, a simple coating with electrically insulative properties may be sufficient, such as liquid Si, siloxanes, polyimides, SiO₂, Si₃N₄, B₃N₄, SiONₓ, etc.; some applications may call for ceramic materials or any other combinations thereof In these cases, the thermal contact requirement between the C/Al composite and the extra layer is to be considered. Furthermore, it may be important that the thermal conductivity properties are good and compatible with the C/Al composite and its ultimate application.

Embodiments of the present invention may insert a ceramic layer in contact with the top and/or bottom surfaces of the C/Al mixed material before casting and thermal treatment as described in the foregoing embodiments. In such a way, a suitable thermal and mechanical contact is achieved, securing excellent and tailored insulative properties of the surface of the final C/Al-ceramic composite.

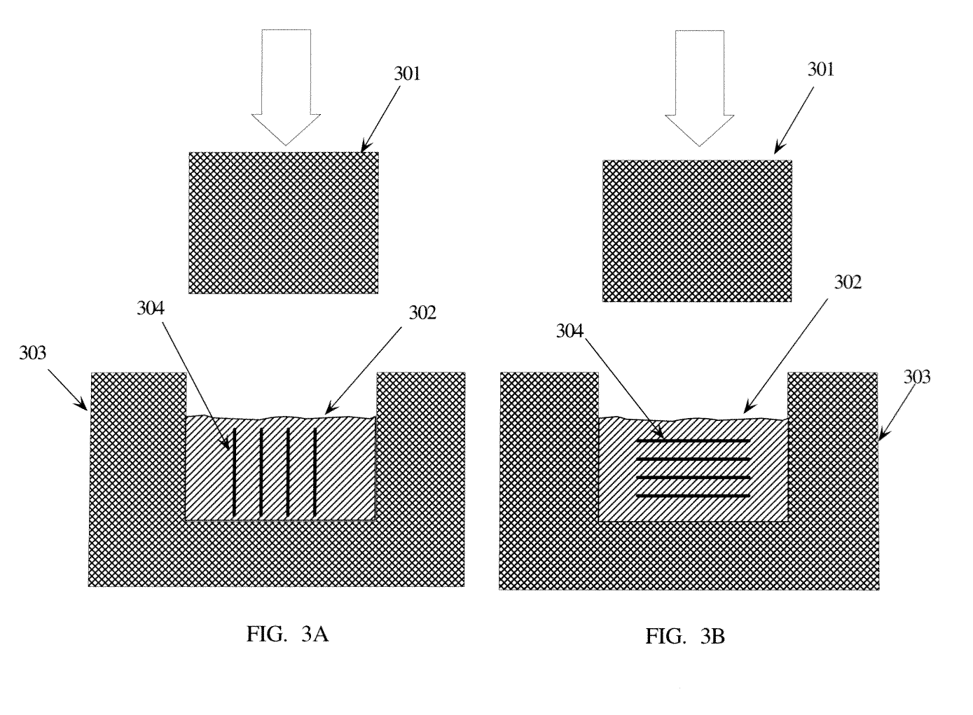

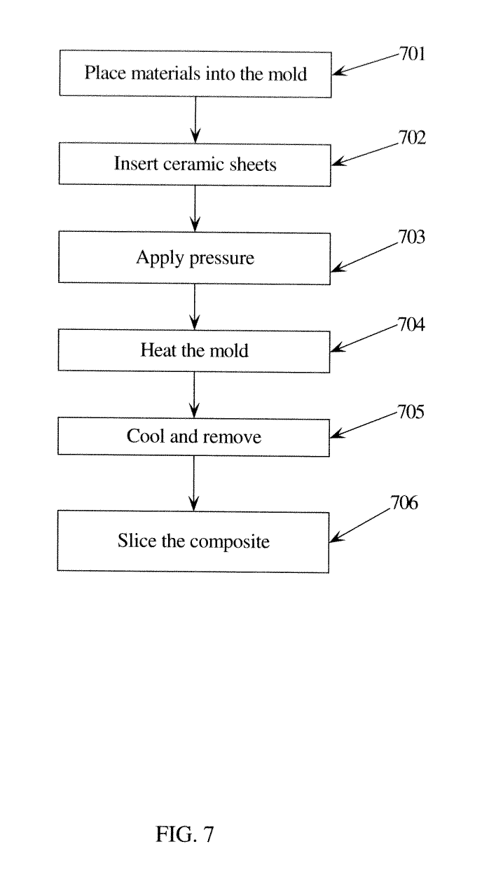

Referring to FIGS. 3A, 3B, and 7, further embodiments of the present invention are described. In step 701, carbon-aluminum powder materials 302, such as the graphitic needle cokes and aluminum particles as utilized in the embodiment described above with respect to FIGS. 1 and 5, graphitic needle cokes and aluminum wires and/or nanowires such as described above with respect to the alternative embodiment described above with respect to FIGS. 1 and 5, or graphitic needle cokes with aluminum coatings thereon such as described above with respect to FIGS. 2 and 6, are placed into a pressure mold 303. Additives, such as silicon, may be included to provide a good thermal contact between the aluminum and carbon materials. The silicon additives may be silicon inclusive materials, such as silicon powders with a powder size smaller than 1 micron, and a preferred powder size of 10-100 nanometers. In step 702, one or more ceramic sheets 304 are inserted into the carbon-aluminum powder materials 302, such as in a parallel fashion, as illustrated in the two embodiments shown in FIGS. 3A and 3B. The ceramic sheets 304 are commercially available, and may be comprised of, but are not limited to, AlN, Al₂O₃, or SiN sheets; a sheet thickness may be 0.1-0.5 millimeters. In step 703, a mechanical pressure (indicated by the arrows in FIGS. 3A and 3B) is applied onto the mixture 302 with a die 301 (e.g., 20-200 MPa). Due to the fact that impregnation of the pores in the carbonaceous matrix is not necessary, the applied pressure may be much lower, for example, less than 50 MPa. In step 704, the mold 303 is heated to about 660° C. or greater for approximately 10 minutes or more to melt the aluminum. An alternative temperature range may be between 700°-750°. To sufficiently obtain a dense composite material, the pressing time may be longer than 10 minutes, such as 10-30 minutes. In step 705, the mixture is cooled to approximately room temperature and removed from the mold 303.

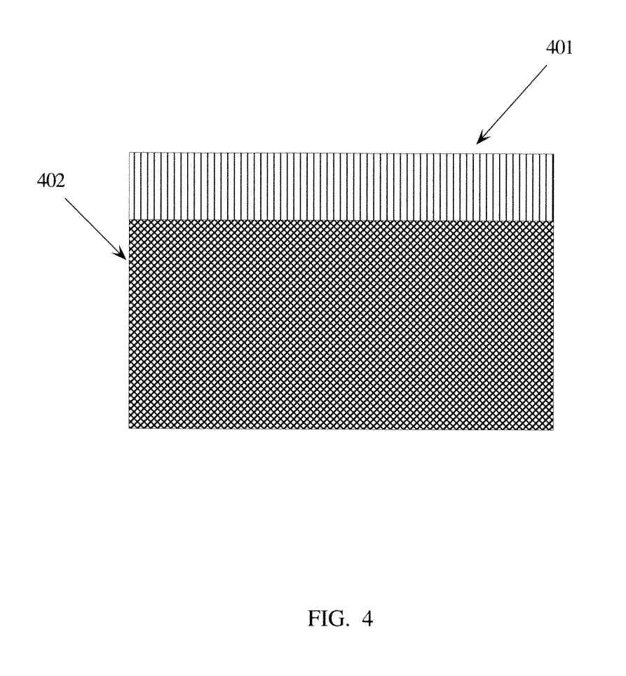

Referring to FIG. 4, the molded composite 302 may be sliced, with a well-known cutting device for such applications, into one or more plate-like shapes 402 so that a section 401 of a ceramic sheet 304 is on each plate 402 surface that is sliced from the molded composite 302.

What is claimed is:

1. A method for making a carbon-aluminum composite comprising pressing a mixture of graphitic particles and aluminum in a heated pressure mold.

2. The method as recited in claim 1, further comprising preparing the mixture of graphitic particles and aluminum by mixing the graphitic particles with aluminum particles.

3. The method as recited in claim 2, wherein the graphitic particles comprise carbon nanotubes.

4. The method as recited in claim 2, wherein the graphitic particles comprise graphitic needle cokes.

5. The method as recited in claim 1, further comprising preparing the mixture of graphitic particles and aluminum by coating the graphitic particles with aluminum.

6. The method as recited in claim 5, wherein the graphitic particles comprise carbon nanotubes.

7. The method as recited in claim 5, wherein the graphitic particles comprise graphitic needle cokes.

8. The method as recited in claim 7, wherein the coating of the graphitic needle cokes with aluminum further comprises dipping the graphitic needle cokes into an aluminum ink followed by thermal curing of the aluminum-coated graphitic needle cokes.

9. The method as recited in claim 7, wherein the coating of the graphitic needle cokes with aluminum further comprises sputtering an aluminum target to deposit aluminum on the graphitic needle cokes.

10. The method as recited in claim 1, wherein the pressing of the mixture of graphitic particles and aluminum in the heated pressure mold is applied at a pressure in a range of 20-200 Mpa.

11. The method as recited in claim 10, wherein a temperature of the heated pressure mold is 660° C. or greater.

12. The method as recited in claim wherein the graphitic particles comprise graphitic needle cokes.

13. The method as recited in claim 1, wherein the pressing of the mixture of graphitic particles and aluminum in the heated pressure mold is applied at a pressure in a range of less than or equal to 50 Mpa.

14. The method as recited in claim 13, wherein a temperature of the heated pressure mold is 660° C. or greater.

15. The method as recited in claim 13, wherein the graphitic particles comprise graphitic needle cokes.

16. The method as recited in claim 15, further comprising adding silicon powders to the mixture before pressing in the heated pressure mold.

17. The method as recited in claim 1, further comprising inserting a ceramic sheet into the mixture before pressing in the heated pressure mold.

18. The method as recited in claim 17, further comprising slicing the carbon-aluminum composite after pressing in the heated pressure mold to produce a plate of the carbon-aluminum composite with a ceramic surface.

19. The method as recited in claim 18, wherein the ceramic sheet is selected from the group consisting of an AlN sheet, a SiN sheet, and an Al₂O₃ sheet.

20. The method as recited in claim 18, wherein the graphitic particles comprise graphitic needle cokes.
